(19) United States
(12) Patent Application Publication
(10) Pub. No.: US 2012/0191788 A1
(43) Pub. Date: Jul. 26, 2012

(54) SYSTEMS AND METHODS FOR CONTROLLING THE DISPLAY OF A USER SELECTABLE COMMUNICATION INITIATOR

(76) Inventor: Melissa Mellen, Amherst, NH (US)

(21) Appl. No.: 13/328,605

(22) Filed: Dec. 16, 2011

Related U.S. Application Data
(63) Continuation-in-part of application No. 13/110,410, filed on May 18, 2011.
(60) Provisional application No. 61/345,706, filed on May 18, 2010.

(51) Int. Cl. G06F 15/16

(52) U.S. Cl. 709/206

(57) ABSTRACT

Methods and systems of facilitating chat sessions or other electronic communications between a consultant and a user are provided. A chat button or other electronic communication initiator is active and displayed to a user on a user device only when an indication of consultant availability is provided. Available time periods may be pre-scheduled and/or a consultant can indicated immediate availability. In this manner, a consultant can maintain an electronic communication schedule, and a user can know a consultant's present availability instantly without contacting the consultant or the consultant's organization.

### CROSS-REFERENCE TO RELATED APPLICATIONS

This application is a Continuation-in-part of U.S. patent application Ser. No. 13/110,410, titled “Internet-Based Consultation Service And On Line Contact Scheduling”, filed May 18, 2011, which claims priority to U.S. Provisional Patent Application No. 61/345,706, titled “Internet-Based Weigh-In Service”, filed May 18, 2010.

### TECHNICAL FIELD

Embodiments of the present invention relate generally to counseling services that are network-based, and more particularly to an innovative process that uses network communication to encourage and facilitate customer goal achievement through the use of interaction with consultants. Embodiments also relate to specialized online communication scheduling and control methods and systems thereof.

### BACKGROUND

Excess weight gain and obesity are major problems throughout the United States and other countries. Excess weight gain can lead to a multitude of health problems. Obesity continues to be the leading preventable cause of death that exists in the world. Many people try to lose weight every year and unfortunately, most are not successful. Many of these individuals may be more likely to achieve their weight loss or other goals if they were to receive positive reinforcement from a consultant or mentor who could help monitor their progress and encourage them to continue to reach their goals.

Many systems and methods are available which allow individuals to communicate with one another using a computer system or other electronic device connected to the World Wide Web, an intranet, or any other suitable network such as a wireless network. Instant messaging, texting, online chatting and Voice over Internet Protocol (VoIP) are but a few examples of such communication systems and methods.

### SUMMARY

In order for an individual to use such communication methods in the context of a commercial endeavor, the user typically contacts a company's contact center via telephone, e-mail or website and inquires as to whether this type of communication service is available to the user at the present time. The availability of the communication service to the user is dependent on various circumstances including the availability of a party to speak with the user; whether the user is authorized to speak to a requested party at the present time, place or date, as well as other criteria.

One way to address these issues is to provide an Internet-based method and system that can assist a user at any time of the day or night, regardless of the user's location, to achieve his or her weight loss or other goals. Further, such methods and systems may include an automated online chat or other computer-based communication control program which may schedule online communication between a user any 3^{rd} party by controlling the user's ability to access the online chat capability based on the user's payment schedule and/or other predetermined criteria. Such a program may be separate from or part of the online chat program, and may be located on the site or server or at a separate location or on a separate server.

Embodiments disclosed herein relate to an innovative process that uses Internet technologies to encourage and facilitate customers in losing weight or achieving some other goal. Although embodiments are discussed in the context of weight loss, this is for exemplary purposes only as the methods and systems disclosed and claimed herein may be used to reach any personal goal or for any other purpose. For example, the communication systems may be used by a doctor and patient to follow up on treatments or symptoms.

Through the use of specialized online scheduling tools of customer weigh-ins, graphical and pictorial tracking of the weigh-ins, online food and nutritional information, reinforcing e-mails and personal on-line “cheerleading”, a consultant cheerleads or encourages her or his customer to achieve weight loss goals. Customers who seek and/or desire additional motivation are able to use a Wi-Fi scale (or other Wi-Fi or computer connectable device) which connects and/or transmits information to the service website and into a customer's account using the Internet or other communication systems at weigh-in times to help keep them on track. The overall program is aimed at providing quick bursts of support, referred to as cheerleading, for a customer on any type of diet and/or exercise regimen. The consultant refocuses the customer to keep the customer on their program. In the context of the description of embodiments herein, it is intended that the consultant may be any of many types of individuals with various roles, credentials and/or education, and that the consultant will not overstep his or her legal or ethical parameters. The term “consultant” may include a “cheerleader”, that is, someone who interacts with users to keep them accountable and encourages them to keep striving for their goal even if they have had a bad week. In some embodiments, the consultant may be a licensed professional such as a doctor, nurse, dietitian, or other professional.

In one embodiment, a new approach to assisting people with weight loss and/or other goals is provided. The approach includes quick motivational consultations and weigh-ins that give time-conscious motivation to keep people on track to reach their weight loss goals. Previous services have focused on in-office visits or long term coaching as part of a motivational process. This service is different in that there is no formal training given to consultants and the consultants will serve the purpose of cheerleader by listening and providing positive feedback to those trying to lose weight. This enables consultants to help anyone on any diet program to accomplish their personal goal.

The consultant uses the website to schedule and participate in online chats, instant messaging, texting or other communication forums with customers at scheduled times, selected by the customer and set by the consultant (e.g., the consultant enters times that they are available to chat and the customers select specific times), and based on the amount of payment provided by the user. The option to select weigh-in times may be governed by additional criteria, either through automated methods, such as a selected payment schedule, or through manual methods such as a consultant entering and/or scheduling the user's scheduled chats.

In some embodiment, a customer selects how much time and how many times he or she wants to log in based on a payment schedule. This information is passed to a scheduler. The customer is then allowed to select up to the amount of time they have paid for. In some embodiments, this time may be set by the consultant, doctor or whoever is controlling the allowed time rather than using automated methods. Once a customer has chosen a scheduled time, an online chat button in the customer's account is active at that time and only at that time (or at multiple times if multiple are selected). The consultant can set the time window for which the button is active. The button turns off and becomes inactive when that time window has passed. For example, the consultant may determine that they will give the user or customer a ten minute window of time in which to login to the online chat feature. After the expiration of that time window, the online chat button either is not visible to the user or becomes inactive until the user's next regularly scheduled online chat time. The online chat scheduling is a new approach to maintaining a scheduled online chat time, and controlling (either in an automated manner or manually) the amount of time that can be scheduled based on various criteria. The chat button will be active for a user during a time window which is selectable by the consultant, thus enabling the consultant to control work flow as has not been done previously. The consultant or the system is thereby capable of manually or automatically controlling the communication scheduling based on a payment schedule and/or other criteria.

The customer provides their weight or other information at the scheduled chat times, either by communicating their weight via a chat session with the consultant or by Wi-Fi scale, or by other Wi-Fi or wireless (i.e. Bluetooth, etc.) equipment. The customer receives feedback or cheer from their consultant to help them stay on their diet. The consultant may enter the data for display in the customer's account or the data may be entered automatically using a Wi-Fi scale or other Wi-Fi or wireless device.

The company may recruit consultants, and may provide consultants with a kit to enable them to set up their own eWeighln business. The consultant may provide this service to individual customers and host companies. The individual customers may have a personal account to access their consultant, online chat, e-mail scheduling, online chat scheduling and personal data. A host company that is a customer may have a corporate account that has a transparent interface, that is the interface will look like the company's website rather than the eWeighln website. The employees of the host company or their customers may have personal accounts through their personalized interface. The consultant may have an interface to service the clients in the same way they would service a single client. Customized services may be used in some circumstances.

To help facilitate customers reaching consultants with whom they feel comfortable, the site may provide a searchable database of consultants. Searches may include consultant information such as how much weight they have lost, how much weight they want to lose, what diets they have used, hobbies, sports, family status, and other personal info, which may include marital status, age, etc. that consultants wish to provide.

To help customers with diet issues, the website may provide a food database. The database can include food nutritional content and diet specific information. This may include information on which foods are acceptable on specific diets, as well as rough cost equivalent foods and other food comparison information (e.g., frozen vs. fresh), which may be aimed at helping people cut food costs and obtain the most nutritious foods available for their money.

According to one embodiment, at least one computer-readable storage medium is provided having computer-readable instructions which, when executed by a processor, perform a method of facilitating electronic communication between a user and a consultant. The method includes an act of receiving an indication of a time at which a consultant is available for electronic communication with a user. The method further includes sending activation information to an electronic user device to cause an electronic communication initiator to be activated at the electronic user device at the time at which the consultant is available such that the user can initiate electronic communication with the consultant via the user device by selecting the electronic communication initiator. The electronic communication initiator is not active during a time period immediately prior to the time at which the consultant is available for electronic communication.

According to another embodiment, a system includes a memory configured to store an indication of a time at which a consultant is available for electronic communication with a user, and a processor. The processor is operative to receive the indication of a time at which the consultant is available for electronic communication with a user. The processor is further operative to send activation information to an electronic user device to cause an electronic communication initiator to be activated at the electronic user device at the time at which the consultant is available such that the user can initiate electronic communication with the consultant via the user device by selecting the electronic communication initiator. The electronic communication initiator is not active during a time period immediately prior to the time at which the consultant is available for electronic communication.

According to a further embodiment, a method includes electronically receiving an indication of a time at which a consultant is available for electronic communication with a user. The method further includes an act of sending activation information to an electronic user device to cause an electronic communication initiator to be activated at the electronic user device at the time at which the consultant is available such that the user can initiate electronic communication with the consultant via the user device by selecting the electronic communication initiator. The electronic communication initiator is not active during a time period immediately prior to the time at which the consultant is available for electronic communication.

It is important to note that embodiments of the present invention are not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of embodiments disclosed herein are further described in the following detailed description and the accompanying drawings, wherein:

FIG. 1 is schematic diagram of a system according to one embodiment; and

FIG. 2 is a flowchart of a method of facilitating electronic communication between a user and a consultant; and

FIG. 3 is a schematic diagram of networked system according to one embodiment.

### DETAILED DESCRIPTION

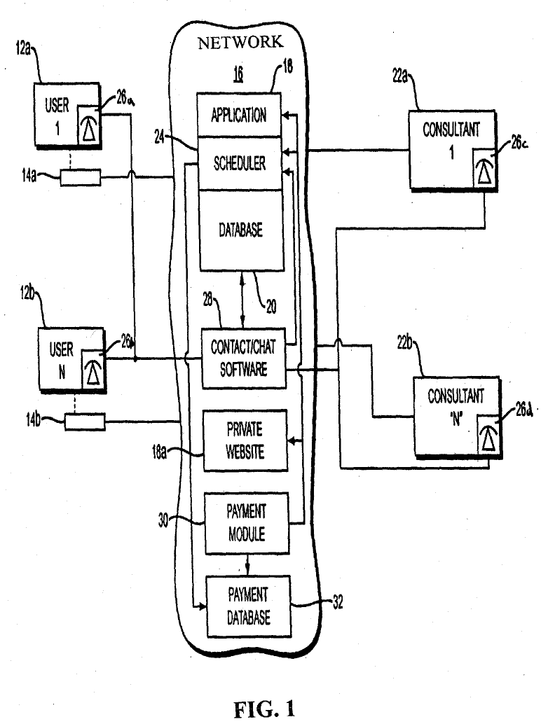

Embodiments disclosed herein include a system and methods of using the system. FIG. 1 shows one embodiment of a system of providing a service that provides a weigh-in service and/or an on-line communication arrangement (using online and/or other electronic device based communication arrangements such as, but not limited to, Instant Messaging (IM); online chat; Skype® communications, a telephone or cell phone or any other suitable arrangement).

Although embodiments are described herein in connection with a weigh-in service, this is not a limitation of the present invention as these principles may be applied to many different services. The electronic communication initiator control feature may be applied to any online chat system or other electronic communication system.

The service encourages and supports an individual or customer by giving them brief or extended positive messages, along with other communications to help them realize their weight loss or other goals. The individual can be participating in any number of traditional diet and/or exercise regimens. The weigh-in service may be sufficiently flexible to accommodate any type of diet and/or exercise of an individual.

The online communication system feature allows a user to communicate with a professional or other consultant, such as a weight loss consultant, on predetermined days and times based on the payments made by the user, or in the case of a non-paying system, based on the directions of an individual such as a doctor or the like. The online communication system further features the ability for the user to have a communication session with a consultant or other individual without logging into a website.

The weigh-in service offers flexibility in the weigh-in process. The weigh-in service model according to an exemplary embodiment gives customers (often referred to as “users” herein) a choice of how many days per week they would like to weigh-in. A customer can weigh-in everyday or weigh-in once per week or any other variation as determined and paid for by the customer. The customer has his or her weight recorded to an individual account (database) 20 that is part of and maintained by the website or application(s) 18 located on a server somewhere on a network 16, such as the World Wide Web, an intranet or other suitable network. The weight data may be communicated by a computer, a smartphone or other communications device, by a phone, by a scale 14a, 14b (such as a Wi-Fi scale) connected directly to the network 16, or the weight data may be communicated by the user electronic device 12a, 12b (such as by a cable to a USB Port) via an online chat or another method.

In one embodiment, each customer (user) is signed up or registered by a consultant. The customer can select which consultant to consult with, or a consultant can be assigned to the customer. The application 18 presents an opportunity for customers to select a consultant from a searchable database of consultants which is part of the database 20 maintained on the application 18. A customer is able to search for a consultant that shares their interests such as, for example, diet interests, weight loss issues, sports interests, hobbies or any other information consultants wish to share with their customers and potential customers. This search feature may help a user locate a consultant that the user feels is best suited to help him or her to achieve a successful weight loss goal. The consultants also may provide additional personal information in the database 20 using videos, presentation program files (e.g., PowerPoint®), or any other suitable method of presenting information. In one embodiment, the consultant records the customer's weight in the customer database which may be part of the application database 20, and gives the customer quick feedback or encouragement. In another embodiment, the customer's weight may be provided directly to the application 18 using the Wi-Fi scale 14a, 14b.

Each customer may have an individual private user account which may or may not be maintained in database 20. The service or application 18 offers customers various services including graphical output of their weigh-in, which will be kept in their private user account. The service also may offer optional advice and consultation from a nutritionist, exercise professional or other relevant consultants. The service further may offer referrals to other consultants or health care professionals. The service may be configured with sufficient flexibility to accept weigh-ins from customers using any diet program or food regimen.

In addition to the time spent speaking with a consultant, the service or application 18 or the consultant may offer the customer random or scheduled e-mail reinforcement for his or her particular program. This feature allows a customer to have e-mails that address specific events (e.g., a visiting parent, weekends, vacations etc.) where the customer expects that he or she may overeat or eat an unhealthy diet, as well as providing e-mails with a selectable motivational style message at specific times of day when a customer may be prone to overeat (e.g., between the hours of two and four in the afternoon).

In some embodiments, consultants may be rewarded or compensated based on the number of users or consumers that they signed onto the program and also based upon the level of service that the user signs up and pays for. In some embodiments, the consultants may be recruited and compensated as employees paid based on worked time or completed services. Customers and/or consultants may be rewarded with public acknowledgement in various venues as deemed appropriate.

The business may recruit, support and monitor consultants. The consultants, however, do not necessarily require extensive specialized training, skills or background because in some embodiments they do not act as nutritionists or personal trainers but instead as cheerleaders. The website may be configured to provide a brief video and/or presentation program file and/or other possible media to potential consultants which explain how the company can help a consultant earn income.

The company may provide a purchasable kit in order to recruit consultants. The kit may include software and/or a special link to the web application 18 that provides an interface for the consultants to access a private account on the website 18. Each account provides a portal to the consultant's online chat office and a scheduler 24, and other social media services accounts such as Twitter® and/or Facebook® account links on the website 18. The account also may include a consultant biography, e-mail accounts including automatic e-mail features, searchable terms, and other marketing options which the consultant may choose to use.

The software also may include an instruction set, which can include video, PowerPoint® and/or other multi-media presentations which explain the company's goals and how the company can support/assist the consultant, what the requirements are for the consultant, what the company has rights to, and a complete payment schedule. The software may further include a database that helps the consultant recruit and track local members on the consultant's computer. The consultant may use a personal computer, or any other device that has an Internet or other network connection, such as a personal digital assistant or other Internet-based device.

Additionally, a program may be included which helps the consultant organize tax information for their consultant business. The software also may include information specializing in specific diets. For example, a consultant may choose to specialize in specific diets, such as a Weight Watchers® diet or a South Beach Diet® in order to provide a specific service of weigh-ins, coaching and diet suggestions for those existing companies and/or specific diets. The software also may include downloadable advertising media such as a brochure, e-mail advertisement, or other forms of advertising and marketing.

The consultant may be provided with the ability to upload a video or use a standard presentation format for their own sales pitch for recruiting customers to become associated with them. This ability will be particularly valuable for on-line inquiries. The consultant may be expected to recruit through personal contacts as well as through e-mails, cold calls, or other forms of recruiting. The consultant may hold home or office parties to discuss and promote his or her services as a consultant as part of recruiting users to become associated with them.

The website or application 18 may also provide the consultants with customers via the Internet. The service may include an online chat interface 28 which records all chats and shows all data provided by the chat software (such as geographical location, duration of chat etc.). The recorded data may be accessible to the service owner for quality control purposes. The data information will be used for cost and effect analysis by both the business and the consultants.

One feature of embodiments disclosed herein is an online scheduler 24 interface that allows the consultant to set the days and times during which they wish to make themselves available for real-time electronic communications and/or weigh-ins. For purposes herein, real-time electronic communications include communication sessions between a user and a consultant performed by chat session, instant messenger (IM), telephone (using a lane line or cell phone) Skype®, texting or other suitable forms of communication. Real-time electronic communications can also include e-mail communication if e-mail is actively monitored by both parties and replies are quickly sent. Online scheduler 24 allows the consultant to set their own hours and to work for as many or as few hours as they determine is appropriate or desirable for their schedule.

In addition to the consultant setting their own schedule to be used by the scheduler 24, some embodiments may include a payment module 30 which allows the user to select a plan and, through the use of any well-known means such as a shopping cart or the like, pay for the plan. The payment information may be inserted into a separate payment database 32 which is accessed by the scheduler 24 to determine when and how many times a user may have access to a consultant based on the payment entered by the user. In this embodiment, the payment information is automatically accessed by the scheduler 24 to automatically schedule chat sessions between the user and consultant.

In addition to the consultant setting their own schedule to be used by the scheduler 24, some embodiments may include a payment module 30 which allows the user to select a plan and pay for the plan over the network. The payment information may be inserted into a separate payment database 32 which is accessed by the scheduler 24 to determine when and how many times a user may have access to a consultant based on the payment entered by the user. In this embodiment, the payment information is automatically accessed by the scheduler 24 to automatically schedule chat sessions between the user and consultant.

As an alternative to the payment plan described above, some embodiments do not require user payment. In other embodiments, a third party may pay for the service. For example, a corporation, Medicare, a health insurance company, or suitable entity may make payments. In this case, a consultant (which may be a doctor, a nurse or other health care professional, is provided with an interface to the scheduler 24 to schedule chats and other conversations with the user. For example, a user who is having heart problems may be provided with a Wi-Fi heart monitor and asked to use the monitor three times per day. Information from the heart monitor is provided directly to the application 18 and entered into the user database 20. In this case, there is no payment required by the user and the nurse acting as the consultant can manually enter in the times as directed by, for example, the doctor. In this embodiment, the present invention also may include an alarm or alert which will alert a consultant or other interested party. The data may automatically enter a user's account and may include red flags which activate alerts, such as an e-mail or an alarm. For instance, if heart monitor reading data is high or wrong, an e-mail or an audible alarm may alert a nurse or doctor. Similarly, if a weight comes in higher than the day before, an automatically generated e-mail may be sent to a consultant suggesting that they contact the contact.

When a customer selects a time using user device 12a, 12b, the scheduler 24 may activate an electronic communication initiator 26a, 26b, such as a chat button, on the user's device 12a, 12b only for a predetermined time period based on available times set forth by the consultant. The scheduler 24 has access to information in the database 20 about the customer and/or consultant, including dates, and time frames at which the consultant is available to provide chat opportunities to the customer, as well as e-mail addresses, IP addresses, Skype addresses and any other relevant information required by either the application or website 18 or the contact/chat software 28 to establish and display a chat opportunity to a user at the appropriate time and for an appropriate time frame. At other times, chat capabilities (or other electronic communication availability) may be not active and/or not displayed.

For example, in some embodiments, if the customer selects to chat with the consultant every Tuesday at 4:00 PM, the application 18, under control of the scheduler 24, causes the electronic communication initiator 26a, which in this embodiment is a chat button, to be displayed and activated on the display portion of the user's device 12a, 12b only at the selected time. Thus, beginning at 4:00 PM on Tuesdays, the chat button is displayed on the user's device 12a, 12b. The duration or length of time in which the chat button is displayed may be set by the consultant. Alternatively, the chat button may be continuously displayed but inactive at all times when the button is not active.

For example, the consultant may instruct the scheduler 24 to allow a five minute or ten minute window of time in which the chat button is available and/or visible to the user. After this time, the chat icon is no longer be visible and/or selectable, and the user has to wait until his or her next regularly scheduled time window to engage with the consultant. This scheduling method enables the consultant to maintain a regular schedule for online chats with customers. If customers are not scheduled for a chat session with a consultant, the customer's online chat button is inactive and/or not visible. This method is thus automatic and does not require the use of a call center or contact center operator to handle an inquiry from a customer only to determine that the customer has not paid for the appropriate consultation or that the consultant is not available. The scheduling or manual operation of chat buttons may be controlled for each separate user account and can be featured on a single or multiple websites.

The electronic communication initiator 26a, 26b may be enabled via automated scheduling which may be performed by the client. To do so, the client selects an available time from the consultant's schedule to reserve a meeting time with the consultant. The client can reserve meetings once they have paid for the meeting. For example, if a client has purchased five meetings, they can reserve up to five meeting times with a consultant. The electronic communication initiator 26a, 26b also may be enabled via manual activation or scheduling by the consultant. Electronic communication initiators other than chat buttons, such as other buttons, may be used in some embodiments. For example, a button may allow a user to link to other systems for communication, such as video conferencing and instant messaging. In some embodiments, video conferencing using Skype® services may be used.

The consultant may also be able to schedule a chat button activation which allows a user to connect with additional content, such as other online chats or web conferences or instant messages that can involve third parties, such as another consultant or professional. The consultant also may provide a user with access to a webpage or e-mail or other access point, which then in turn contains access to an online chat feature available to the user in some embodiments.

When the consultant connects the user to another consultant or professional, this connection may involve the creation and appearance of one or more electronic communication initiators (e.g., chat buttons). For example, when multiple chat buttons are implemented, a first chat button on user device 26a links to the main consultant at a consultant device 22a, while a second chat button (or other electronic communication initiator) on user device 26a may link to a second consultant having a second consultant device 22b, and a third chat button may link to another professional or expert. Some embodiments use multiple buttons that link to multiple consultants and/or experts and/or other links to additional content. For example, a first button may be a chat button for chatting with a first consultant, a second button may be a videoconferencing button for video conferencing with an expert, and a third button may be an instant messaging button with a third party. Consultant device 22a may have an electronic communication initiator 26c, e.g., a chat button, and consultant device 22b may have an electronic communication initiator 26d.

In some embodiments, the online chat feature may require that the user login to the application or website 18 in order to participate in and/or be made aware of the online chat feature and capabilities. In this embodiment, the chat feature may be run by and through the application 18.

In other embodiments, it is contemplated that the server and/or application 18 may further include a separate contact/chat software module 28 which provides the online chat features and which configures and provides the chat capabilities without requiring a user to be logged into the application 18. The contact/chat software 28 may receive inputs from the database 20 and/or the scheduler 24 (as well as the payment module 30 and/or payment database 32) to schedule the times and dates that a user is allowed to chat with a consultant.

The assistive software provided to the consultants also may include instructions for setting up a Twitter® account, a Facebook® account or other social media account. Through these various social media, the consultant engages in positive messaging with their customers. Preferably, the consultant makes contact with their customers on a daily or weekly basis. The consultants are provided with tools to select and schedule positive e-mails for their customers. The consultants may add new e-mails to the database on the main site. The software may also include other options and services for the consultants.

In some embodiments, the software programs facilitate setting up a complete business for the consultant. The technical support may be provided via online chat which can be scheduled thru an online scheduling system, by phone, in person, in group meetings or any other communication venue, all of which may employ the use of the online scheduling program.

The website 18 may be used as a the major marketing tool, explaining the features that the weigh-in service has and how it may benefit the customer. The website 18 may permit the consultants to provide a weigh-in service through a customer's personal account. The customer may be able to search an online consultant database 20 to locate the best consultant to meet their needs. The database 20 may be searchable by the consultant's (diet) experience how much weight they have lost, how much weight they are trying to lose and information regarding hobbies, marital status, family status, etc. In this way, the customer can find a consultant who they feel they can best relate to who has or has had similar experiences, goals and lifestyles.

Customer accounts may provide access to their consultant's schedule in conjunction with the payment module 30 and payment database 32. Customers may be able to access the weigh-in service from any user device 12a, 12b that has access to the network 16. Customers may be able to schedule weigh-ins at a specific time or at specific time intervals. For example, a customer can schedule a weigh-in from 10:00 AM-10:15 AM. The customer logs into their account and finds an active chat icon at their scheduled weigh-in time. When the chat icon is active, the customer can chat with their consultant regarding their weight and/or any other weight-related issues they are having. The online chat button will be inactive at other times when the customer does not have a scheduled weigh-in. The consultant will have the ability to turn the chat button 29 on or off manually or automatically. For example, when the consultant logs off, is unavailable, or is away from their computer, the chat button 26 disappears from the customer's display or show as inactive. The consultant also may manually turn off the chat button if they do not want to be available for chat. If the customer fails to show up at the scheduled time, an automatic e-mail or consultant's e-mail may be triggered and sent at varying intervals to encourage communication from the customer.

The consultant can screen their communication with each user by manually turning on or off the chat button 26 generally and/or associated with one or more users. In this manner, the consultant can hide from one or more users by appearing unavailable or offline, and the consultant can “appear” and chat with a user if they see them online or if they desire to make themselves available to chat with a user. The consultant can do this in real time, thereby instantly making themselves unavailable or available, or alternatively they can schedule times when they will appear unavailable or available. The consultant can manually turn off or on the chat button with one or more users, while manually turning off or on the chat button with one or more other users. In this way, the consultant can chat with one or more users and appear available while at the same time other users see the consultant as unavailable.

The website 18 also may offer a database of reference materials which may assist the customer in their (weight loss) goals. These databases may include food types, nutritional data, and a variety of applicable diets. The database may include information about different diet types, types of foods that should be eaten or should be avoided and other reference materials. The information on the website also may offer rough food cost equivalents or recommendations for nutritional value (e.g., fresh vs. canned vs. frozen). For example, the information may offer comparison data about different types of food, their nutritional values and their costs. The website also may include recipes that can be used for different types of food and different diets, each with calorie count. In some embodiments, the customer is able to assemble full menus from the website database for their chosen daily caloric intake.

Additionally, the customer may be able to schedule a consultation online with a different consultant such as a nutritional consultant, exercise professional, healthcare provider or other third party as an extra cost option. The ability to online schedule such a consultation will also be coupled to and driven by the payment module 30 in the user's payment database entries 32.

The consultant may be responsible for setting up the 3^{rd} party consultations in some embodiments. The consultant can distribute online chat buttons 26 to 3^{rd} parties. In this manner, a three way conversation can occur between the consultant, the 3^{rd} party and the user, or it can result in a two way conversation between the 3^{rd} party and the user can occur without involving the consultant. The consultant does not have to use the scheduler 24 to enable the additional chat buttons 26 in some embodiments. The one or more chat buttons 26 setup by the consultant for the user can be scheduled immediately or be used for future appointments. For example, a chat button may appear for a live video conference, which only appears as active when the live video conference is scheduled to occur.

The chat buttons 26 can be used for anything that needs to be scheduled. For example, if a user suffers from seasonal affective disorder, a disorder that particularly affects people in the winter months, a consultant can setup a chat button to appear in the winter months only. This chat button 26 can link the user to a seasonal affective disorder professional, one or more a seasonal affective disorder websites, or to other web related links that the consultant thinks might be helpful to the user.

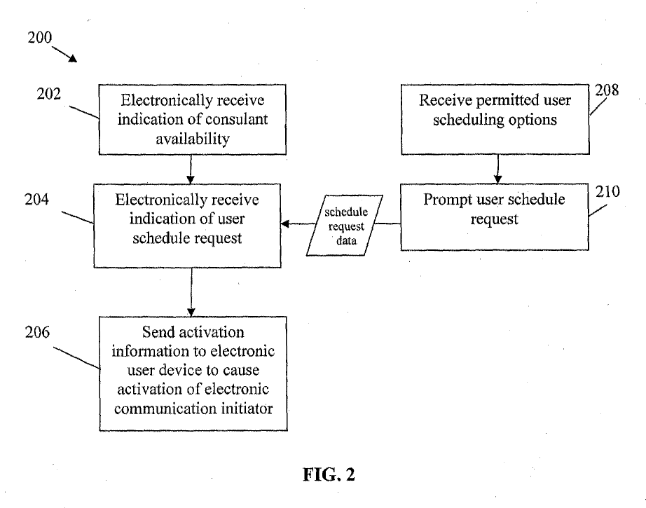

A method 200 of facilitating electronic communication between a user and a consultant is shown in a diagram in FIG. 2. In an act 202, a processor, controller or computer electronically receives an indication of consultant availability. The indication may be received directly from a consultant's electronic device or via a network. The indication may be received in any suitable format, including a data file of dates and times. In some embodiments, the indication may be received as an indication that the consultant is presently available. A user schedule request is received in an act 204. Based at least in part on the indication of the consultant's availability, activation information is sent in an act 206 to an electronic user device to cause activation of an electronic communication initiator. In some embodiments, act 204 may not take place, and the method may proceed directly from act 202 to act 206.

In some embodiments, permitted user scheduling options are received in an act 208. For example, a user may purchase three blocks of consultant time. Based on this purchase, a scheduling module of a program may permit a user to schedule no more than three blocks of consultant time. In an act 210, the user may be prompted to enter their schedule requests up to a limit of what the user has purchased. The schedule request(s) may be sent to the processor which receives the user schedule request indication.

In some embodiments, in addition to, or instead of, purchase limits, other limits may be placed on user counseling requests. For example, a limit to the number of blocks of consultant time request per a certain time period may be imposed.

A group of users may also use embodiments presented herein. When there is a group of users, there can be multiple online chat activations or placement of buttons simultaneously.

The consultations described herein can be done online, by phone or in person, or any suitable combination thereof. The customer has an account that contains all of the customer's data including the online charting of the customers weigh-in progress. The customer has access to an e-mail section of the scheduler 24, which they can set to automatically send an e-mail when they need extra incentive or they can request the consultant select and schedule the e-mail. The customer also may have a link to his or her consultant's Twitter® account and Facebook® account, as well as a link to the weigh-in site 18. The customer may be able to receive direct marketing and other functions from the consultant's personal account as well as the weigh-in site. The customer may have a suggestion box in their account where they are free to suggest any new thoughts for the business or the consultant.

In some embodiments, a direct customized weigh-in website service can be offered to a host company. Some examples of host companies that may employ this weight loss program include gyms, doctor's offices, weight loss centers, insurance companies and other private companies. In such an embodiment, the host company customizes a log in and subsidiary website 18a that permits companies to offer the weigh-in service to their employees or customers using the host company's branded image or logo on the subsidiary site 18a. The subsidiary site appears to be operated as the host company's website such that a user of the service associates the service with the host company. This direct customized weigh-in website service would provide a seamless look to the host company, wherein the interface would appear to be a website from the host company. This service may be offered to a host company as a benefit that can be offered to employees. The service at a given host company may be associated with one consultant who provides services as described herein to any employees at the host company who participate in the service.

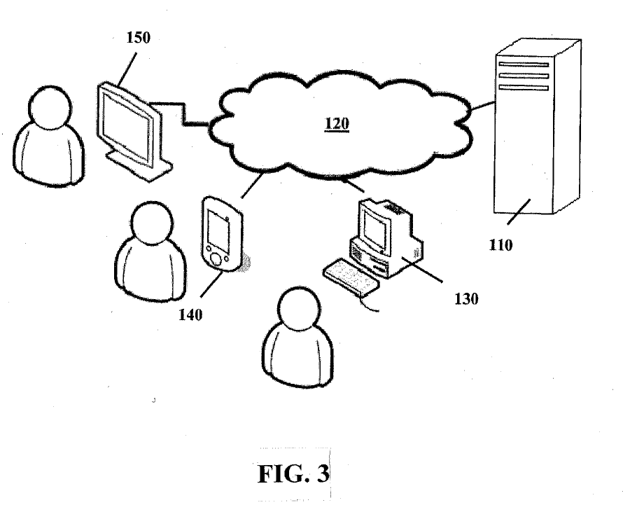

According to some embodiments, a processor, such as a server device, receives and sends information associated with electronic communication initiation as described herein. For example, as shown in FIG. 3, a server device 110 is connected via a network 120 such as the Internet, to a plurality of client devices. Each of the client devices may be any suitable device which allows either a customer or a consultant to receive and send information via the network, such as a computer 130, a mobile phone 140, or a display device 150 having a touch screen interface. For purposes of this paragraph, the term “client device” refers to a user device and/or a device used by a consultant. Any other suitable devices, such as a tablet computer or a personal digital assistant, may be used as client devices. Server device 110 may be a central computer which is programmed to send information to the client devices, and further programmed to receive information such as scheduling information from the client devices. In some embodiments, the server device may be distributed among, and implemented on, multiple platforms. For example, a first device may direct a second device at a different location from the first device to send information to client devices. The first device then may receive responses from the client devices. The server device may obtain information to be sent to client devices from a computer storage medium that is part of the same physical device as the processor, or the server device may obtain the images from a computer storage medium that is located remotely from the server device. For purposes herein, the term “send”, when referring to sending images, requests, and/or other data, includes sending data from a first device, as well as instructing and/or causing a second, different device to send data.

It is important to note that the present invention is not intended to be limited to a system or method which must satisfy one or more of any stated or implied objects or features of the invention. It is also important to note that the present invention is not limited to the preferred, exemplary, or primary embodiment(s) described herein.

Modifications and substitutions by one ordinary skill in the art are considered to be within the scope of the present invention which is not to be limited except by the allowed claims and their legal equivalents.

What is claimed is:

1. At least one computer-readable storage medium having computer-readable instructions which, when executed by a processor, perform a method of facilitating electronic communication between a user and a consultant, the method comprising:
receiving an indication of a time at which a consultant is available for electronic communication with a user;
sending activation information to an electronic user device to cause an electronic communication initiator to be activated at the electronic user device at the time at which the consultant is available such that the user can initiate electronic communication with the consultant via the user device by selecting the electronic communication initiator, the electronic communication initiator being not active during a time period immediately prior to the time at which the consultant is available for electronic communication.

2. The computer-readable storage medium of claim 1, wherein sending activation information comprises sending activation information to cause the electronic communication indicator to be displayed on the electronic user device at the time at which the consultant is available, the electronic communication initiator being not displayed during a time period immediately prior to the time at which the consultant is available for electronic communication.

3. The computer-readable storage medium of claim 1, wherein the electronic communication initiator comprises a chat button configured to cause a launching of a chat window upon selection of the chat button.

4. The computer-readable storage medium of claim 1, wherein the electronic communication initiator comprises a video conferencing button configured to cause a launching of a video conferencing session upon selection of video conferencing button.

5. The computer-readable storage medium of claim 1, further comprising receiving an indication of one or more time periods at which the user desires to communicate with the consultant, the number of time periods being limited by a purchase amount provided by the user.

6. The computer-readable storage medium of claim 1, wherein receiving an indication of a time at which a consultant is available for electronic communication comprises receiving an indication of a time period in the future.

7. The computer-readable storage medium of claim 1, wherein receiving an indication of a time at which a consultant is available for electronic communication comprises receiving an indication of availability at the present time.

8. A system comprising:
a memory configured to store an indication of a time at which a consultant is available for electronic communication with a user; and
a processor operative to:
receive the indication of a time at which the consultant is available for electronic communication with a user; and
send activation information to an electronic user device to cause an electronic communication initiator to be activated at the electronic user device at the time at which the consultant is available such that the user can initiate electronic communication with the consultant via the user device by selecting the electronic communication initiator, the electronic communication initiator being not active during a time period immediately prior to the time at which the consultant is available for electronic communication.

9. The system of claim 8, wherein the processor is operative to send activation information to cause the electronic communication indicator to be displayed on the electronic user device at the time at which the consultant is available, the electronic communication initiator being not displayed during a time period immediately prior to the time at which the consultant is available for electronic communication.

10. The system of claim 8, wherein the electronic communication initiator comprises a chat button configured to cause a launching of a chat window upon selection of the chat button.

11. The system of claim 8, wherein the processor is further operative to receive an indication of one or more time periods at which the user desires to communicate with the consultant, the number of time periods being limited by a purchase amount provided by the user.

12. The system of claim 8, wherein the processor is configured to receive an indication of a time period in the future as the indication of a time at which a consultant is available for electronic communication.

13. The system of claim 8, wherein the processor is configured to receive an indication of availability at the present time as the time at which a consultant is available for electronic communication.

14. A method comprising:
electronically receiving an indication of a time at which a consultant is available for electronic communication with a user;
sending activation information to an electronic user device to cause an electronic communication initiator to be activated at the electronic user device at the time at which the consultant is available such that the user can initiate electronic communication with the consultant via the user device by selecting the electronic communication initiator, the electronic communication initiator being not active during a time period immediately prior to the time at which the consultant is available for electronic communication.

15. The method of claim 14, wherein sending activation information comprises sending activation information to cause the electronic communication indicator to be displayed on the electronic user device at the time at which the consultant is available, the electronic communication initiator being not displayed during a time period immediately prior to the time at which the consultant is available for electronic communication.

16. The method of claim 14, wherein the electronic communication initiator comprises a chat button configured to cause a launching of a chat window upon selection of the chat button.

17. The method of claim 14, wherein the electronic communication initiator comprises a video conferencing button configured to cause a launching of a video conferencing session upon selection of video conferencing button.

18. The method of claim 14, further comprising receiving an indication of one or more time periods at which the user desires to communicate with the consultant, the number of time periods being limited by a purchase amount provided by the user.

19. The method of claim 14, wherein electronically receiving an indication of a time at which a consultant is available for electronic communication comprises receiving an indication of a time period in the future.

20. The method of claim 14, wherein electronically receiving an indication of a time at which a consultant is available for electronic communication comprises receiving an indication of availability at the present time.
